(19) United States
(12) Patent Application Publication
(10) Pub. No.: US 2026/0064448 A1
(43) Pub. Date: Mar. 5, 2026

(54) Interactive Page System

(71) Applicant: Ramin Bolouri, Concord, CA (US)

(72) Inventor: Ramin Bolouri, Concord, CA (US)

(21) Appl. No.: 19/313,861

(22) Filed: Aug. 28, 2025

Related U.S. Application Data
(60) Provisional application No. 63/688,234, filed on Aug. 28, 2024.

(51) Int. Cl. G06F 9/451; G06F 40/40

(52) U.S. Cl. CPC G06F 9/453; G06F 40/40

(57) ABSTRACT

A web page embeds an AI-driven widget that converts static content into an interactive experience. Executable code builds a page interaction index from the page's DOM, including text, selectors, and positional metrics for DOM nodes. In response to natural-language input, pipelines perform summarization, stepwise explanations, voice-guided form completion with rule-based validation, and on-page product scanning to create a dynamic, user-tunable comparison table. Results are rendered as in-place overlays with interactive back-references that highlight source DOM nodes in the viewport. Speech recognition and text-to-speech enable multimodal interaction. Optional privacy gating redacts sensitive data or routes processing to local models. The system improves webpage usability by binding AI outputs to precise DOM regions and providing unified, context-aware assistance within the page.

### STATEMENT REGARDING FEDERALLY SPONSORED RESEARCH OR DEVELOPMENT

Not applicable. No federal funds were used in the development of the subject matter described herein.

### NAMES OF PARTIES TO A JOINT RESEARCH AGREEMENT

Not applicable.

### REFERENCE TO A SEQUENCE LISTING, A LARGE TABLE, OR A COMPUTER PROGRAM LISTING APPENDIX ON READ-ONLY OPTICAL DISC (IF APPLICABLE)

Not applicable. No sequence listing, large table, or computer program listing appendix is submitted on read-only optical disc.

### FIELD OF THE INVENTION

The disclosure relates to human-computer interaction on the World Wide Web and, more particularly, to an AI-driven widget embedded in a web page that converts static content into an interactive environment by building a DOM-anchored page interaction index and providing summarization, stepwise voice-guided form assistance with rule-based validation, and dynamic product comparison tables within the page.

### BACKGROUND OF THE INVENTION

Static web pages often require users to read lengthy text, manually parse instructions, fill multistep forms, and compare numerous products scattered across a single page or across multiple pages. Existing tools address individual tasks—e.g., generic page summarizers, browser autofill, voice input layers, or off-page comparison shopping—but they typically (i) operate in isolation, (ii) are not consistently bound to the exact source regions of the current page, and (iii) provide limited accessibility and privacy controls for sensitive contexts.

Known summarizers present snippets detached from the exact DOM nodes, limiting explainability; voice-enablement layers accept speech but do not create AI-guided, rule-aware form flows; and comparison shopping tools often aggregate content from external pages rather than live-linking a table to the current page's product list. There remains a need for a single, page-embedded orchestration widget that unifies these operations, binds every output to precise DOM regions, and provides in-place overlays with back-references, privacy gating, and vertical-specific behavior.

The approach disclosed herein addresses these deficiencies by introducing a page interaction index that ties AI outputs and UI overlays back to exact DOM nodes and by unifying summarization/explanation, voice-guided form assistance, and dynamic product comparison within a single widget.

### BRIEF SUMMARY OF THE INVENTION

In one aspect, a method includes injecting, upon user activation, a widget that builds a page interaction index from a page's Document Object Model (DOM). The index stores, for multiple nodes, text, a CSS selector, and positional metrics sufficient to compute viewport bounding regions. In response to a natural-language user request for summarization, explanation, form assistance, or product comparison, the widget selects a pipeline, computes a result using text and metadata from the index, and renders an in-place overlay that displays the result with interactive back-references that highlight and scroll to corresponding DOM nodes.

In another aspect, a system provides voice-guided form navigation. The widget detects forms, derives per-field metadata (labels, types, validation rules), progresses step-by-step via speech with read-back confirmations, and programmatically focuses and highlights invalid fields while recording mappings to DOM nodes in the page interaction index.

In another aspect, a non-transitory medium stores instructions for scanning product containers in the current page's DOM, extracting attributes (e.g., title, price, features), and populating a dynamic, user-tunable comparison table whose cells retain pointers to source nodes such that user interactions highlight the source and page updates propagate into the table.

Optional embodiments include local speech-to-text with privacy gating, accessibility announcements compliant with WAI-ARIA roles, embeddings for node retrieval, and vertical configurations for retail, healthcare, real estate, and services.

The disclosed techniques improve computer functionality by binding AI outputs to exact DOM regions via a persistent page interaction index, enabling voice-guided form flows that programmatically focus and validate fields, and producing live-linked comparison tables consistent with dynamic page scripts.

### BRIEF DESCRIPTION OF THE SEVERAL VIEWS OF THE DRAWING

The drawings illustrate exemplary embodiments of a REAL-TIME CATEGORIZED LEARNING SYSTEM. Like reference numerals denote like elements across the several views. This section lists each figure by number with a concise statement of what it depicts, consistent with USPTO guidance to include a listing of all figures by number together with corresponding explanatory statements.

FIG. 1 is a block diagram of the overall system architecture 100, showing external data sources 102/104/106, an ingress gateway 122, event bus 120, storage components 140/142/144/146/148/149, a categorization stack 160/162/166/168, a rules engine 180, privacy and audit components 260/262/264, online serving 240/242/244/246/248, observability 280-288, and client applications 300/302/304.

FIG. 2 is a flow diagram of real-time ingestion and normalization, illustrating data sources 102/104/106 entering a stream gateway 122, followed by a normalizer 124, deduplication/anomaly filter 128, windowing service 126, publication to the event bus 120, and persistence to a raw store 140 and metadata/configuration database 149.

FIG. 3 is a block/flow diagram of online categorization and confidence scoring, showing events from the bus 120 processed by a categorizer model 160, confidence calibrator 162, category mapper 166, and thresholds/business rules 168, with an override path via rules engine 180, an explanation engine 164, and delivery to the API gateway 240 and inference service 242.

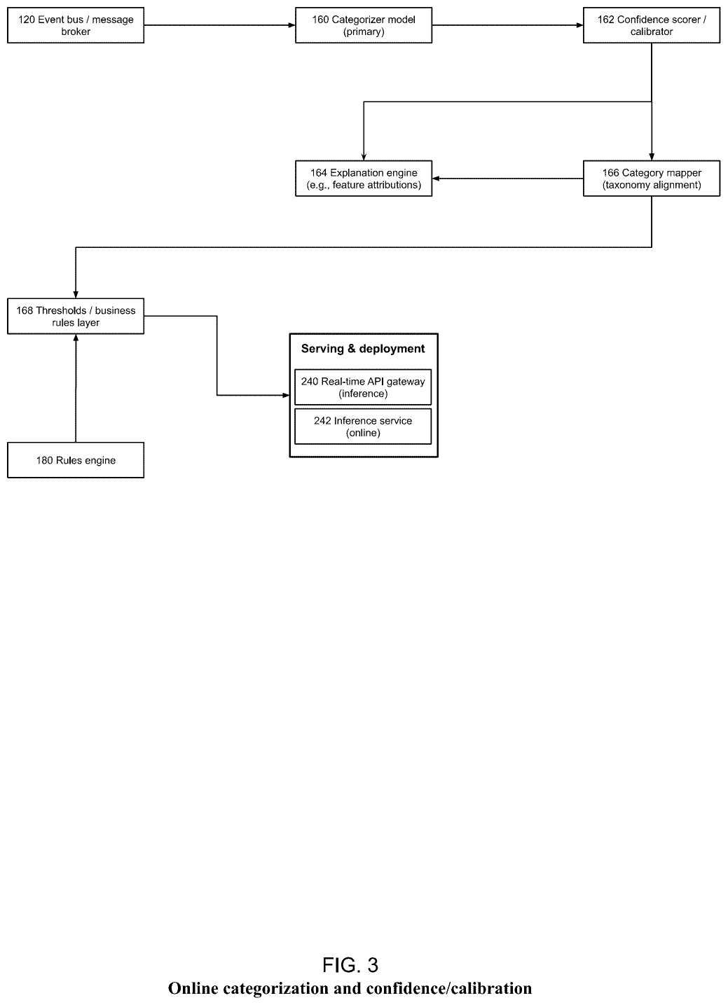

FIG. 4 is a block diagram of taxonomy management, with a taxonomy manager 182 editing a category graph 184 stored in a taxonomy store 144, optionally importing from an external knowledge base 108, and supplying mappings to the category mapper 166.

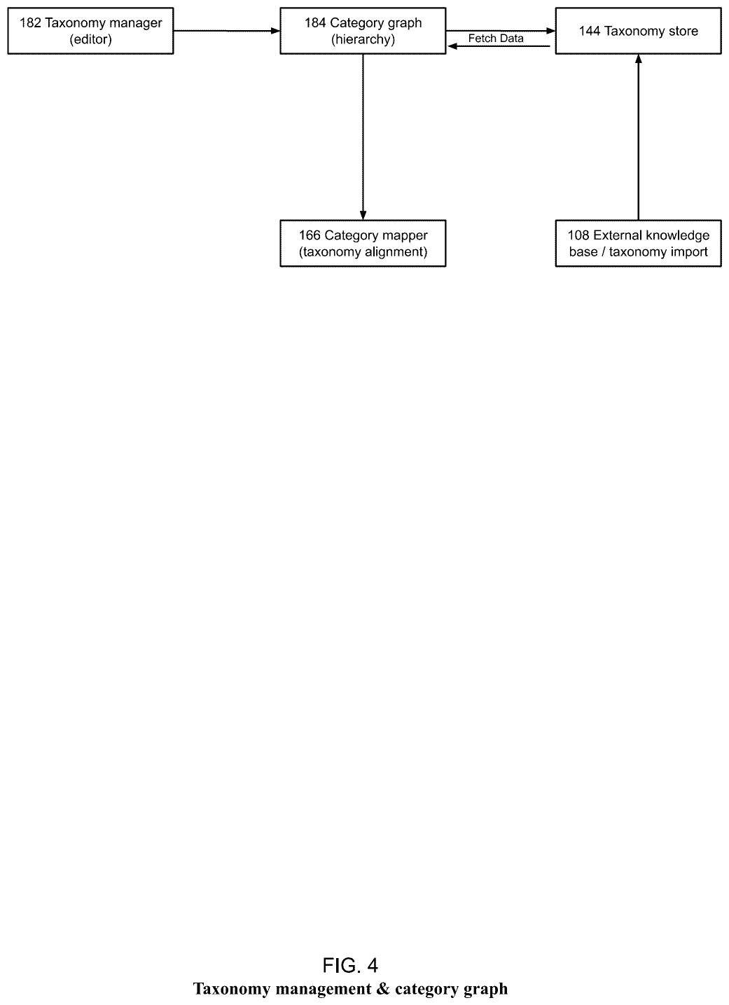

FIG. 5 is a flow diagram of privacy and consent gating, showing ingress 122 passing through a PII/PHI redactor 260 and consent manager 262, with audit logging 264, before requests proceed to the API gateway 240 and inference 242.

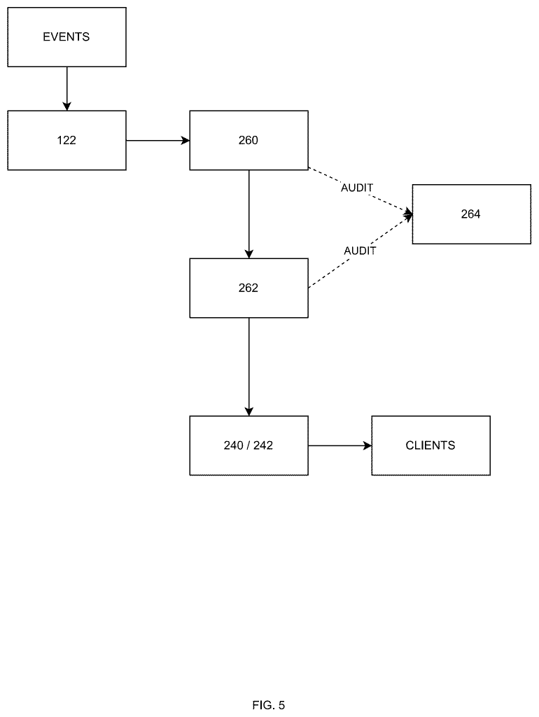

FIG. 6 is a flow diagram of human-in-the-loop labeling and review, illustrating an active-learning selector 202 routing items to a labeling UI 200, review queue 204, and quality controller 206, with gold labels persisted to a label store 148 and used by a training orchestrator 220 and training data builder 222.

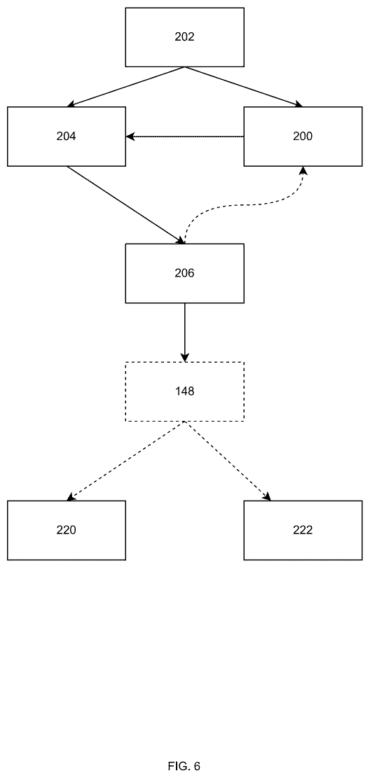

FIG. 7 is a flow diagram of drift detection and retraining, in which a drift detector 224 triggers a retraining sequence via the orchestrator 220, data builder 222, and retraining job 226, with artifacts stored in a model registry 146, evaluated by a metrics service 228, and rolled out under an A/B controller 230.

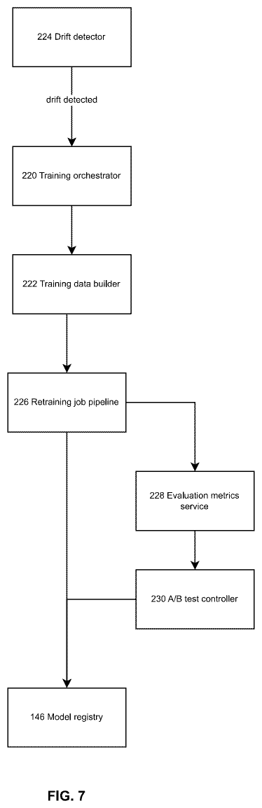

FIG. 8 is a block diagram of deployment and routing, showing models from the registry 146 advanced by a canary deployer 248 through a model router 246 to the inference service 242, with responses cached at the edge 244 and exposed through the API gateway 240.

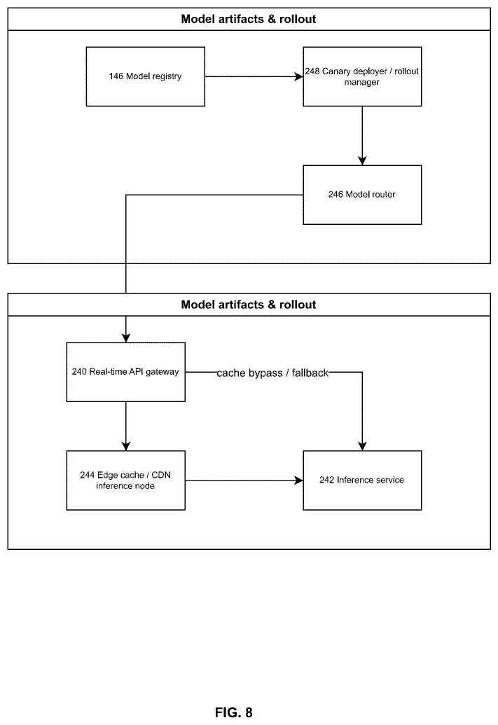

FIG. 9 is a block diagram of observability and service-level monitoring, depicting telemetry from inference 242 and edge cache 244 aggregated by observability 280, with latency monitoring 282, accuracy monitoring 284, surfacing to an operations dashboard 286 and an admin console 302.

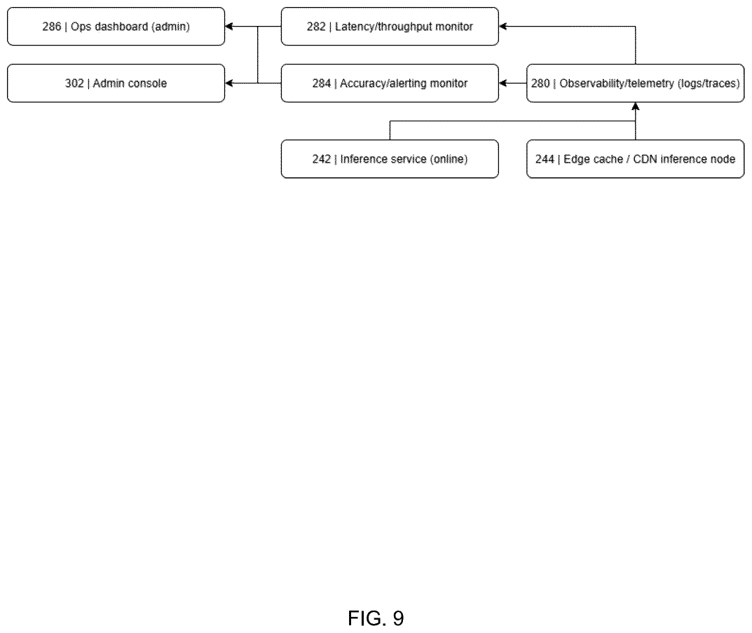

FIG. 10 is a flow diagram of the explanation pathway, showing outputs from the categorizer 160 processed by an explanation engine 164 to generate rationales aligned with the category mapper 166, with optional persistence of explanation metadata in 149.

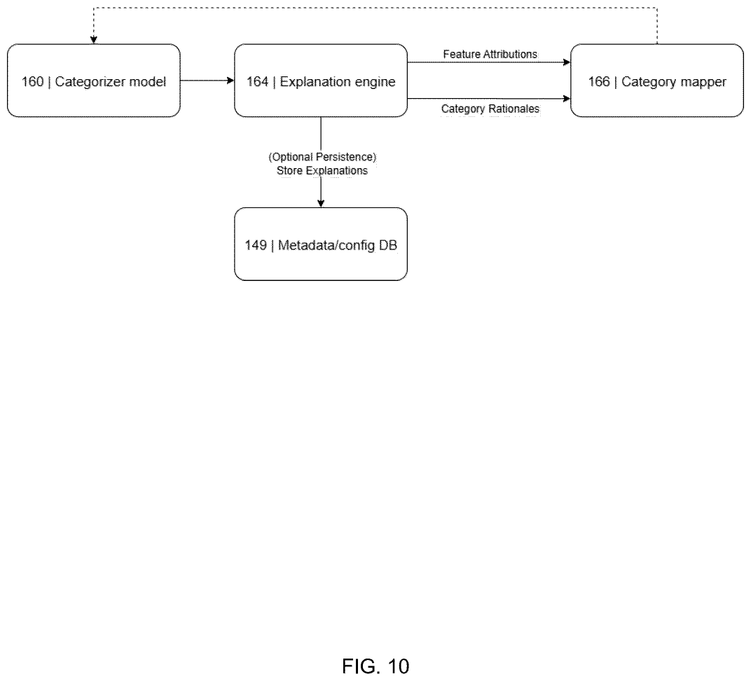

FIG. 11 is a block diagram of client consumption and notifications, illustrating responses issued by the API gateway 240 to a client app 300 and partner integrations 304, as well as webhook notifications via 306 and end-user insights via 288.

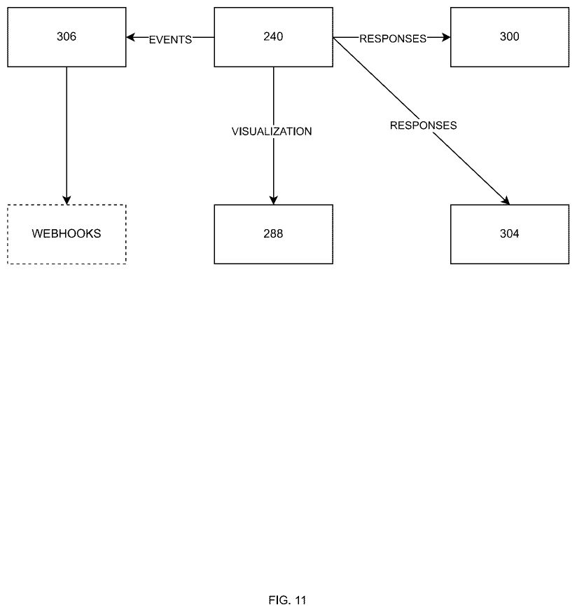

FIG. 12 is a state diagram of the category lifecycle, showing transitions from uncategorized to candidate, validated, and deployed states, with transitions driven by the active-learning selector 202, quality controller 206, evaluation 228, and canary deployment 248.

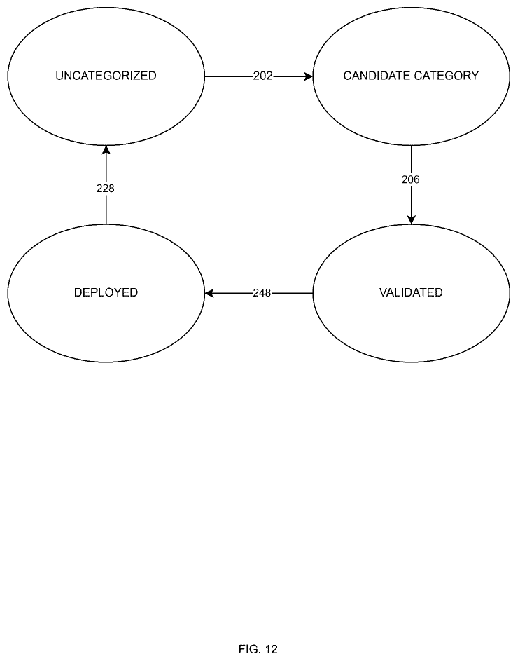

### DETAILED DESCRIPTION OF THE INVENTION

### Overview and Notation

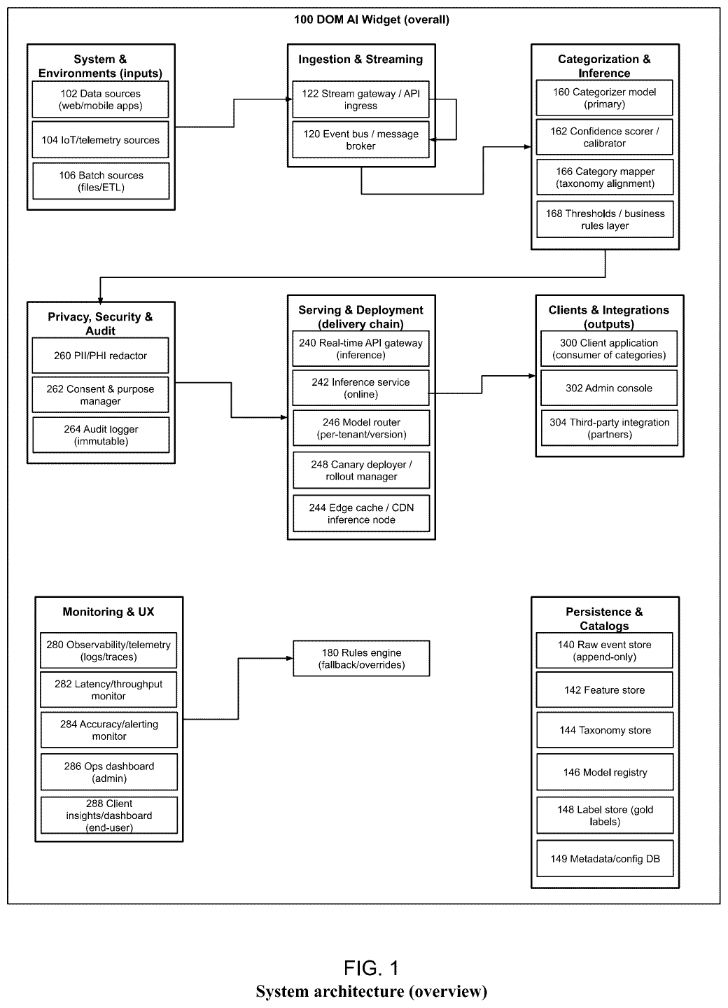

Referring to FIG. 1, system 100 includes a client device executing a browser that renders a web page. An embedded widget (e.g., a lazily-loaded JavaScript component) injects overlay UI elements into the page when activated (e.g., via a floating button). A speech interface provides automatic speech recognition (ASR) and text-to-speech (TTS). A server hosts natural-language models, an orchestration service, and optional vector services. A page interaction index is generated and stored in memory accessible to the widget and/or mirrored on the server. A privacy/consent gate governs routing of data to local or remote models.

The examples herein are illustrative and not limiting. The word “comprising” is used in an open-ended sense. Singular terms include plural forms unless context dictates otherwise.

### The Page Interaction Index

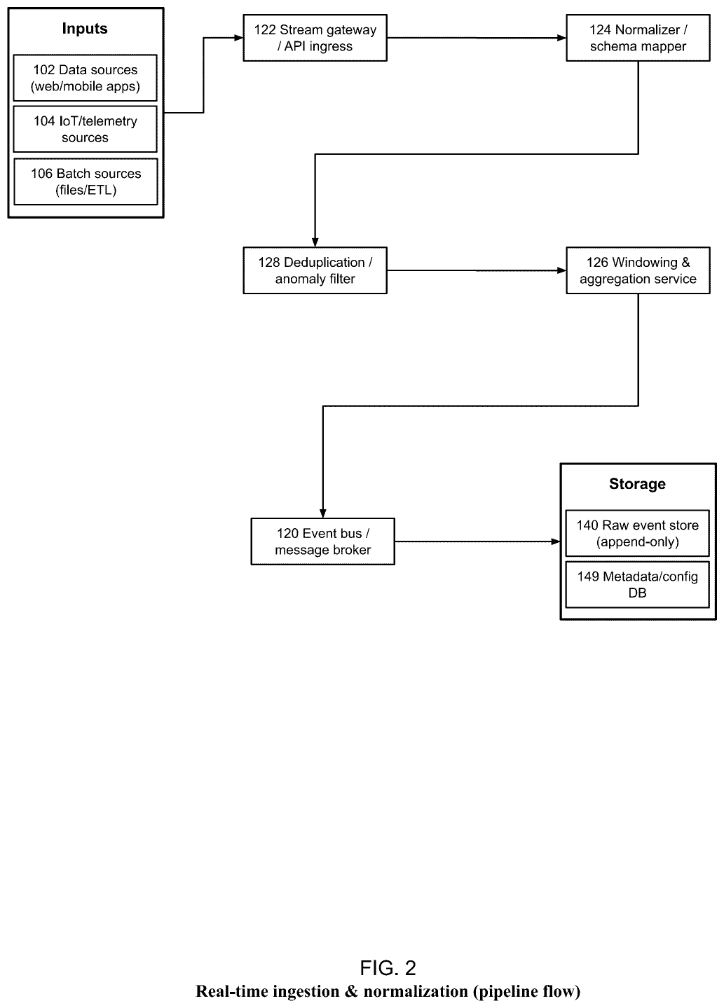

With reference to FIG. 2, the widget traverses the DOM and constructs a page interaction index that, for each selected node, stores: (i) a selector (CSS or equivalent unique path); (ii) normalized visible text or alt text; (iii) offsets in extracted text; (iv) a bounding rectangle in viewport coordinates; (v) role/attributes (e.g., ARIA role, id, name, type, required, pattern, min/max, custom data-attributes); (vi) provenance metadata (timestamp, URL, referrer, script ownership if determinable); and (vii) an optional vector embedding of the node text for retrieval-augmented operations.

The widget may harvest schema. org JSON-LD and ARIA attributes to improve semantic mapping (e.g., offers. price, aria-labelledby), which increases precision in downstream operations.

### Summarization and Explanation Pipelines

Upon receiving a user request for “summarize this page,” the widget selects candidate nodes via heuristics (e.g., main content container, headings, paragraphs) and/or embedding similarity against the user query; sends text spans (with node identifiers) to a summarization model; annotates the returned summary with references to originating node identifiers; and renders an in-place overlay atop the page, each sentence having a control to highlight and scroll to its source node.

For explanation requests, the widget identifies instructional sequences (e.g., ordered lists or headings signaling steps) and renders callouts adjacent to corresponding DOM nodes. Selecting a callout toggles highlight on the DOM node and reveals expanded guidance.

### Voice-Guided Form Assistance with Rule-Based Validation

The widget locates form elements, derives per-field metadata (labels via for/id, proximity, or ARIA), infers input types, and extracts rules from attributes (required, pattern, min, max, maxlength) and, where present, from associated scripts (e.g., regex patterns or function logic parsed statically or via runtime hooks).

In operation, the user may say “Start the form.” The widget enters a stepwise progression with TTS prompts, ASR capture, read-back confirmation, and validation. On a validation failure, the widget programmatically focuses the field, applies a highlight via the field's bounding box, and speaks an actionable prompt. Each prompt/violation is recorded in the page interaction index as a mapping to the relevant DOM node.

Accepted values are inserted by dispatching native DOM events to preserve page validators and analytics. Accessibility announcements (e.g., ARIA live regions) are emitted for screen readers. The speech interface may support barge-in to skip, repeat, or correct a field via natural-language reference to the field's label.

### Product Scanning and Dynamic Comparison Table

The widget scans the DOM for product containers by CSS patterns, roles (e.g., role=“article”), or schema. org markers. For each product, attributes are extracted (title, price, features, merchant, shipping, returns). A comparison table overlay is drawn within the current page. Each cell stores a pointer {sourceSelector, attributeKey}. Filters (price ranges, feature flags) and weighted ranking are applied client-side; a rationale view explains ranking. A mutation observer propagates DOM changes (e.g., price updates) to affected cells without full rebuild.

### Privacy, Security, and Consent

A privacy/consent gate inspects inputs and candidate outputs for PII/PHI using pattern detectors and lightweight classifiers. If sensitive content is present and the user has not opted in, the widget either (i) executes locally (on-device ASR, small summarizer), (ii) redacts sensitive spans prior to server calls, or (iii) prompts for consent. Transport is encrypted; logs may be tokenized and stored with differential privacy where configured.

### Accessibility

The widget provides keyboard parity, assigns ARIA roles to overlays, and issues polite or assertive announcements for focus changes, error states, and navigation, ensuring equivalent interactive guidance for assistive-technology users.

### Vertical-Specific Embodiments

Retail: Additional attributes include merchant, shipping policy, and return window; the ranking function may incorporate total cost including shipping, delivery estimate, and seller rating.

Healthcare portals: The form flow includes explicit consent prompts, local PHI checks, and minimal logging (tokenized); sensitive fields may be dictation-only with local ASR.

Real estate: Product containers correspond to property listings; the table normalizes price-per-square-foot, HOA fee, school rating, walkability, and time-to-downtown, each metric retaining a pointer to the source node.

### Exemplary Implementation (Best Mode)

Frontend: A React widget, lazy-loaded; a Web Worker performs tokenization and embeddings; MutationObserver tracks DOM changes; overlay positioning is computed from per-node bounding boxes in the page interaction index.

Speech: Whisper or similar for ASR (local or server); Web Speech API or on-device voices for TTS.

Backend: A Node. js gateway; Python services (e.g., FastAPI) for NLP pipelines; ONNX Runtime/TensorRT for model serving; optional FAISS/pgvector for element-level embeddings.

Security: TLS; CSP headers; consent dialogs; data minimization by default.

### Definitions (Selected)

“Page interaction index”: A data structure storing, for each selected DOM node, at least a selector, text, positional metrics (bounding box and/or offsets), and optional semantic metadata (roles, attributes, embeddings), used to anchor overlays and back-references.

“In-place overlay”: A UI element injected into the same page that displays results while preserving the underlying page context.

“Back-reference”: An interactive control that, when activated, scrolls to, focuses, and/or highlights a corresponding DOM node identified in the page interaction index.

“Product container”: A DOM subtree representing a single item in a list or grid of items.

“Validation rule”: A constraint derived from HTML, ARIA, script logic, or configuration that governs permissible field input.

### Advantages

The disclosed widget improves browser-page interaction by (i) binding AI outputs to exact DOM regions via a persistent page interaction index; (ii) enabling voice-guided form flows that programmatically focus and validate fields; and (iii) producing live-linked comparison tables that remain synchronized with dynamic page scripts—each constituting concrete improvements in GUI behavior and system usability.

1. A computer-implemented method of providing interactive assistance on a web page rendered in a browser, comprising: injecting, by executable code associated with an embedded widget, user-interface elements into the page in response to a user activation;
building, from a Document Object Model (DOM) of the page, a page interaction index that stores, for multiple respective DOM nodes, textual content, a CSS selector for each node, and positional metrics sufficient to compute a bounding region in the viewport;
receiving via the widget a natural-language user request that invokes one of a summarization operation, an explanation operation, a form-assistance operation, or a product-comparison operation; selecting a pipeline for the invoked operation; computing, by at least one natural-language model operating locally or on a backend, an operation result using the textual content linked in the page interaction index; and rendering, in the page, an in-place overlay that displays the operation result together with interactive back-references that, when selected, highlight one or more corresponding DOM nodes by applying a visual effect to the bounding region derived from the page interaction index.

2. A system for interactive web page assistance, comprising: a client device executing a browser; an embedded widget integrated into a web page displayed by the browser; a speech interface configured for automatic speech recognition and text-to-speech; a server comprising processors and memory storing models for natural-language understanding; and a page interaction index stored in memory accessible to the widget and comprising mappings between DOM nodes and associated metadata; wherein the widget is configured to: detect a web form in the DOM; derive per-field metadata including a label, input type, and validation rule from attributes or associated markup; present a voice-guided, step-by-step progression through the fields; confirm dictated entries by reading back slot values using text-to-speech; validate each entry against a corresponding validation rule; and, upon a validation failure, generate an in-context prompt that programmatically focuses the corresponding input element and instructs a correction, wherein the in-context prompt is recorded in the page interaction index as a mapping to a DOM node such that user selection of the prompt scrolls the associated field into view and applies a highlight.

3. A non-transitory computer-readable medium storing instructions that, when executed by one or more processors, cause a widget embedded in a product-listing web page to: scan the DOM for product containers; extract from each product container attributes comprising at least a title, price, and feature text; populate a dynamic comparison table rendered as an overlay within the current page; filter and rank rows of the comparison table in response to user criteria; and maintain for each cell a pointer to a source DOM node such that user interaction with the cell triggers highlighting of the node in the underlying page and updating of the cell when the node's content changes due to page scripts.

4. The method of claim 1, wherein the page interaction index further stores element-level embeddings generated from the textual content, and selecting the pipeline includes comparing a query embedding to the element-level embeddings.

5. The method of claim 1, wherein the explanation operation generates stepwise explanations of an instructional sequence on the page and renders callouts adjacent to respective DOM nodes corresponding to the steps.

6. The method of claim 1, wherein the in-place overlay provides bidirectional navigation between sentences of a summary and source passages by toggling highlights on the corresponding DOM nodes.

7. The method of claim 1, wherein the widget uses schema. org JSON-LD or ARIA attributes to improve node identification prior to building the page interaction index.

8. The method of claim 1, wherein speech input captured via the browser is locally transcribed by an on-device speech-to-text model when privacy settings require local processing, and otherwise by a cloud service, with the selection recorded in the page interaction index.

9. The method of claim 1, wherein the form-assistance operation includes autocompletion suggestions accepted by voice confirmation and inserted using DOM events that trigger native page validators.

10. The method of claim 1, wherein the widget enforces a privacy gate that detects personally identifiable or protected health information in a candidate response and either redacts the content or requires explicit user consent before rendering.

11. The system of claim 2, wherein validation rules are derived from HTML constraint attributes, associated scripts, or patterns learned from prior interactions on a same domain.

12. The system of claim 2, wherein the speech interface supports barge-in to allow a user to skip, repeat, or correct any field by natural-language reference to the field's label.

13. The system of claim 2, wherein the widget emits accessibility announcements describing each step and field state in compliance with WAI-ARIA roles.

14. The medium of claim 3, wherein the comparison table is live-linked so that price or inventory changes caused by asynchronous scripts in the page automatically propagate to table cells without a full rebuild.

15. The medium of claim 3, wherein user criteria include multi-attribute filters and weighted scoring, and the widget displays an explanation of the ranking rationale.

16. The method of claim 1, wherein the widget records user feedback ratings per operation and updates routing among summarization, answering, form guidance, and comparison pipelines accordingly.

17. The method of claim 1, wherein the widget exposes a developer configuration API permitting site owners to enable or disable specific operations per page type and to define domain-specific synonyms for fields and product attributes.

18. The method of claim 1, applied to retail, wherein product attributes further include merchant, shipping policy, and return window, and the comparison table highlights total cost including shipping.

19. The method of claim 1, applied to healthcare portals, wherein the form-assistance operation prompts for consent language, checks for protected health information locally, and stores only tokenized interaction logs.

20. The method of claim 1, applied to real-estate listings, wherein the comparison table normalizes values to price-per-square-foot, homeowners association fee, school rating, and walkability, each metric linked to its source DOM node.
